(19) United States
(12) Patent Application Publication
(10) Pub. No.: US 2007/0232371 A1
(43) Pub. Date: Oct. 4, 2007

(54) Radio communication apparatus

(75) Inventors: Kouji Soekawa, Kawasaki (JP); Shinsuke Shimahashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/727,961

(22) Filed: Mar. 29, 2007

(30) Foreign Application Priority Data
Mar. 31, 2006 (JP) 2006-100023

(51) Int. Cl. H04M 1/00; G08B 23/00

(52) U.S. Cl. 455/575.5; 340/693.1

(57) ABSTRACT

A radio communication apparatus includes a housing; a battery for driving the radio communication apparatus; an antenna provided in the housing and arranged around the battery; and a magnetic sheet arranged around the battery.

### BACKGROUND OF THE INVENTION

1. Field of the Invention

The present invention relates to a cellular phone equipped with a contactless integrated circuit (IC) card. More specifically, the present invention relates to an arrangement of a magnetic sheet in a cellular phone.

2. Description of the Related Art

Recently, the popularity of multifunctional cellular phones equipped with contactless IC cards has increased.

For example, a user of a cellular phone can make a purchase i.e., a food using the cellular phone carried by the user by means of electronic money stored in a contactless IC card even if the user has no cash or credit card. The contactless IC card is an IC card having an antenna through which it can send and receive data using low-intensity radio waves emitted from an external terminal with which the data is exchanged. The contactless IC card is configured to generate power for activating the card itself from external radio waves or the like.

Unlike contact IC cards, the contactless IC card allows the user to perform a transaction without bringing it into contact with a reader terminal, and is advantageous in that it is suitable for use in an environment where a high-speed transaction is needed. For example, the user of the cellular phone can quickly pay train or bus fare by electronic money stored in the contactless IC card.

In order to improve the reception sensitivity of the antenna used in the contactless IC card, there is a need to remove a metal from around the antenna so as not to impede transmissions and receptions of radio waves. However, a metal typically needs to be placed around the antenna to install the contactless IC card in the cellular phone, and a magnetic sheet is therefore provided between the antenna and the metal to ensure high sensitivity reception of the antenna.

FIG. 1 shows a structure of a cellular equipped with a contactless IC card in the related art.

In FIG. 1, in order to clarify the position of a magnetic sheet, components located in the vicinity of the magnetic sheet are illustrated in a hierarchical fashion.

A contactless IC card system is formed of an IC section 101 and an antenna 102.

The IC section 101 is mounted on a printed circuit board 106. The antenna 102 is formed so as to surround a battery 105 of the cellular phone in order to reduce the thickness of the cellular phone. A magnetic sheet 104 for improving the communication characteristics of the antenna 102 is bonded to the bottom surface of a battery cover 103. The magnetic sheet 104 can suppress a magnetic flux produced by eddy currents flowing through the top surface of the battery 105.

FIG. 4 is a schematic diagram showing the current flow when the antenna 102 is arranged around the battery 105.

When the antenna 102 is arranged around the battery 105, currents flowing in the antenna 102 and the battery 105 produce a magnetic field.

Eddy currents 402 and 403 whose direction is opposite to the direction of a current 401 flowing in the antenna 102 are induced on the top surface and side surface of the battery 105, respectively. The eddy currents 402 and 403 produce a magnetic field opposite to the magnetic field produced by the antenna 102. As a result, the magnetic field of the antenna 102 is weakened to degrade the communication characteristics. The eddy current 403 induced on the side surface of the battery 105 is larger than the eddy current 402 induced on the top surface of the battery 105.

FIG. 5 is a diagram showing a magnetic field distribution when the magnetic sheet 104 is bonded to the battery cover 103.

The battery cover 103 is designed to cover the battery 105. When the battery cover 103 is attached to the cellular phone, the magnetic sheet 104 is arranged in the vicinity of the top surface of the battery 105.

In FIG. 5, the magnetic field strength is given by brightness. The brighter, the higher the magnetic field strength, whereas the darker, the lower the magnetic field strength.

The magnetic field in the vicinity of the antenna 102 is strong. A frame 501 represents a region in which the battery 105 is positioned, and the inside of the frame 501 is darker than the outside. That is, the magnetic field strength inside the frame 501 is lower than that in the vicinity of the antenna 102. The magnetic field strength over an entire magnetic field observation surface 502 is, for example, 32,819 μA/m.

A cellular phone equipped with a contactless IC card is disclosed in Japanese Laid-Open Patent Application No. 2005-117354. The cellular phone disclosed in the above-mentioned publication includes a battery pack having a built-in antenna for achieving a contactless IC card function, and a clearance is formed between the battery pack and the antenna. The cellular phone has an advantage in that the contactless IC card function can be built in the cellular phone without increasing the thickness of the cellular phone.

However, the cellular phone disclosed in the above-mentioned publication also needs to be provided with a magnetic sheet.

Further, the structure in which the magnetic sheet 104 is bonded to the bottom surface of the battery cover 103 causes a maintenance problem in that the magnetic sheet 104 may be removed from the battery cover 103 when replacing the battery 105.

### SUMMARY OF THE INVENTION

Accordingly, it is an object of the present invention to provide maintainability, in which a magnetic sheet is not removed from a battery cover when a user replaces a battery, while improving the communication characteristics of an antenna of a contactless IC card.

According to a preferred embodiment of the present invention, a radio communication apparatus includes a housing; a battery for driving the radio communication apparatus; an antenna provided in the housing and arranged around the battery; and a magnetic sheet arranged around the side surface of the battery.

In the radio communication apparatus according to the preferred embodiment, the antenna may be in the form of a loop, and may be arranged so as to surround the battery.

In the radio communication apparatus according to the preferred embodiment, the magnetic sheet may be arranged inside the loop of the antenna.

In the radio communication apparatus according to the preferred embodiment, the magnetic sheet may be arranged so as to be spaced from the battery.

In the radio communication apparatus according to the preferred embodiment, the magnetic sheet may further be arranged so as to be spaced from the antenna.

According to the embodiment of the present invention, a cellular phone with improved communication characteristics' of an antenna of a contactless IC card and superior maintainability is achieved.

### BRIEF DESCRIPTION OF THE DRAWINGS

FIG. 1 is a schematic diagram showing a magnetic sheet mounted in a cellular phone of the related art;

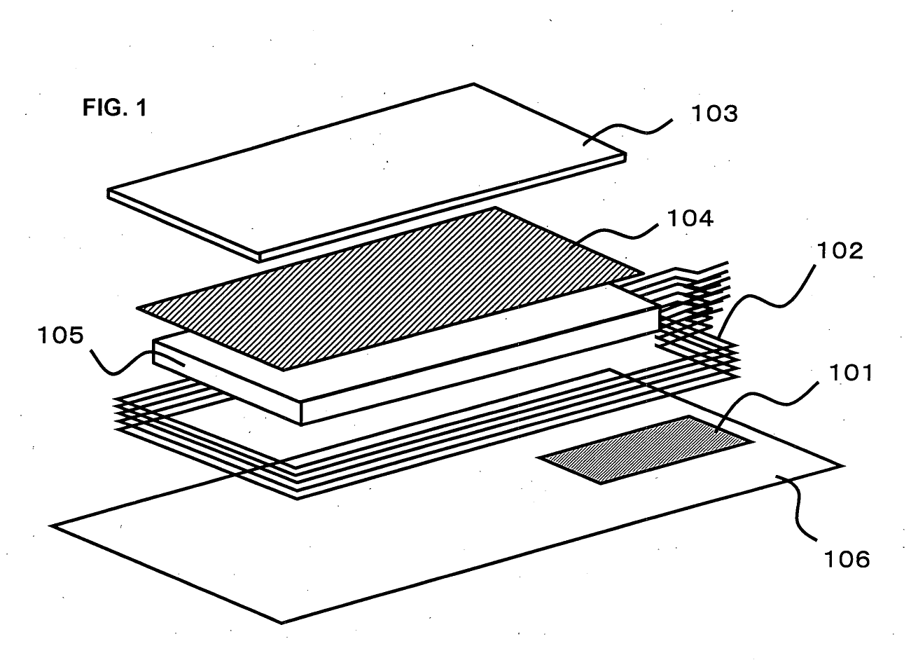

FIG. 2 is a schematic diagram showing a magnetic sheet mounted in a cellular phone according to a preferred embodiment of the present invention;

FIG. 3 is an exploded perspective diagram showing the mounting of the magnetic sheet in the cellular phone according to the preferred embodiment of the present invention;

FIG. 4 is a schematic diagram showing the current flow when an antenna is arranged around a battery according to the related art;

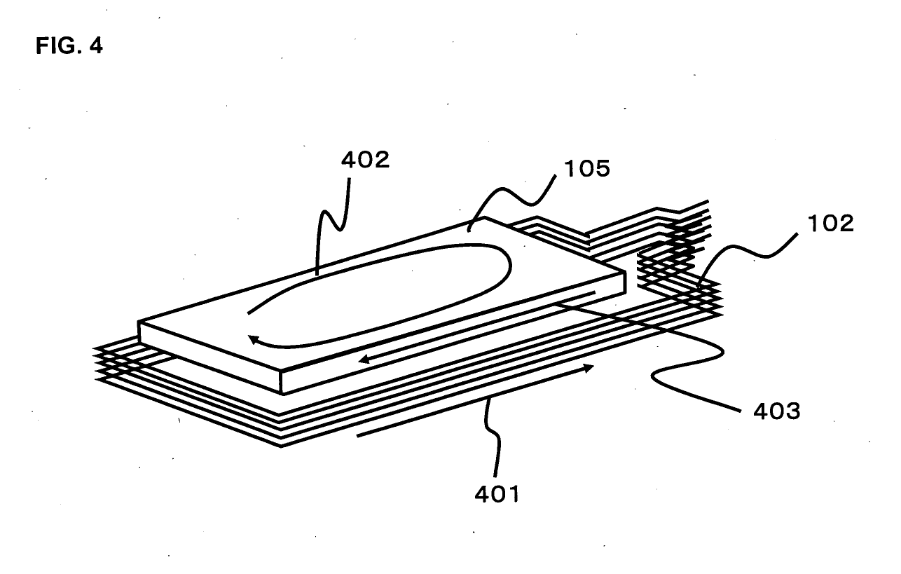

FIG. 5 is a diagram showing a magnetic field distribution when a magnetic sheet is bonded to a battery cover according to the related art;

FIG. 6 is a diagram showing a magnetic field distribution when a magnetic sheet is arranged around a battery according to the embodiment of the present invention; and

FIG. 7 is a hardware block diagram of an IC section 201.

### DETAILED DESCRIPTION OF THE PREFERRED EMBODIMENTS

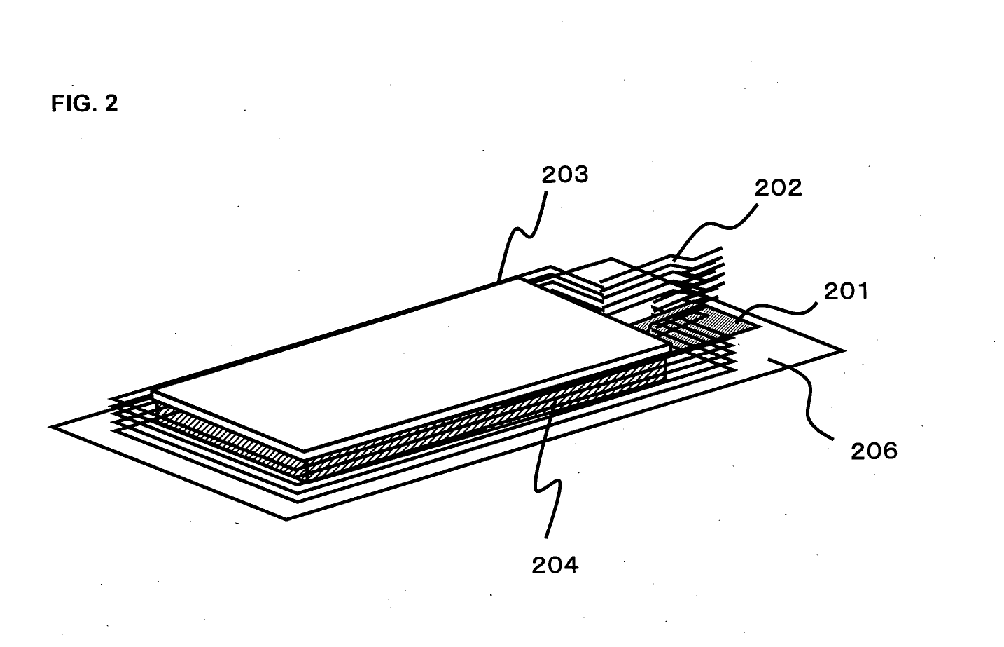

FIG. 2 is a schematic diagram showing a magnetic sheet 204 mounted in a cellular phone according to a preferred embodiment of the present invention.

An information processing apparatus equipped with a contactless IC card according to a preferred embodiment of the present invention will be described in the context of a cellular phone. It is to be understood that the information processing apparatus equipped with the contactless IC card is not limited to a cellular phone, and may be an information processing apparatus in which a contactless IC card can be installed, such as a personal computer (PC) or a personal digital assistance (PDA).

In the schematic diagram of FIG. 2, only a portion near the mounting position of the magnetic sheet 204 according to the preferred embodiment is illustrated.

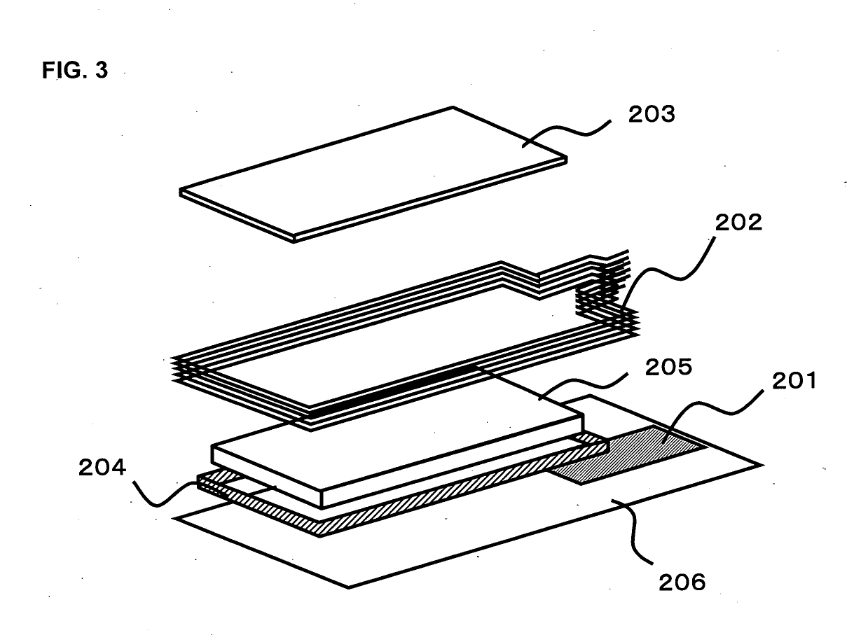

An IC section 201 is mounted on a printed circuit board 206. The printed circuit board 206 is a board on which electronic components for performing communication control and the like on the cellular phone are mounted. An antenna 202 for generating power, for driving the IC section 201 is arranged around a battery 205 (see FIG. 3). The battery 205 supplies power for performing communication control on the cellular phone and application control on other devices such as a camera. The magnetic sheet 204 is used to suppress a magnetic field induced by eddy currents produced on the battery 205, and is arranged around the battery 205.

The IC section 201 and the antenna 202 comprise a contactless IC card system according to the preferred embodiment.

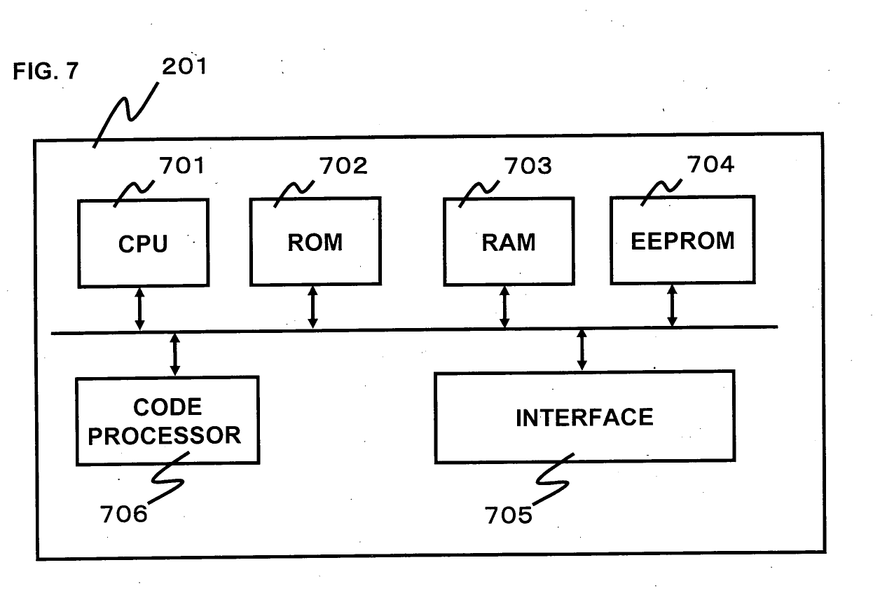

FIG. 7 is a hardware block diagram of the IC section 201.

The IC section 201 includes a central processing unit (CPU) 701, a read-only memory (ROM) 702, a random-access memory (RAM) 703, an electronically erasable and programmable read only memory (EEPROM) 704, an interface device 705, and a code processor 706. The CPU 701 controls the processing in the IC section 201. The ROM 702 stores a predetermined application program for performing the processing in the IC section 201. The RAM 703 temporarily stores data to be exchanged by the IC section 201 to read and write the data. The EEPROM 704 is designed to hold data even when the power supply of the IC section 201 is turned off, and stores user data related to the user of the cellular phone. The interface device 705 performs communication control between the IC section 201 and an external device, and is implemented by a contactless analog communication circuit in the preferred embodiment. The code processor 706 is a dedicated processor for performing cryptographic computation in the IC section 201. Instead of using the EEPROM 704, any other medium, such as a flash memory, may be used to store the user data. The EEPROM 704 may store the application program.

The antenna 202 generates power for activating the IC section 201 from radio waves emitted from a reader/writer. The antenna 202 is formed into a loop, and is wound around the battery 205 a plurality of turns. As the number of turns of the antenna 202 increases, the magnetic field generated becomes strong. The number of turns of the antenna 202 is determined so as to supply sufficient power for communication in the IC section 201.

The magnetic sheet 204 is arranged around the battery 205 inside the loop of the antenna 202. In the preferred embodiment, the magnetic sheet 204 is spaced from the battery 205, and is also spaced from the antenna 202.

A battery cover 203 is designed to cover the battery 205.

The cellular phone includes a control unit, a storage unit, a transmission/reception unit, a display unit, an operation unit, a communication control unit, a speech processing unit, a speaker, and a microphone.

The control unit is formed of a computer including a CPU, an ROM, and an RAM, and controls the storage unit, the transmission/reception unit, the display unit, and the operation unit. The control of these components is performed by executing a control program stored in the ROM of the control unit. The control program is not necessarily stored in the ROM, and may be stored in any other recording medium corresponding to the ROM.

The storage unit is a collection of a ROM, a RAM, and so forth, and may be a removable recording medium. The storage unit may be implemented by a memory whose storage contents are not lost even when the power supply is disconnected, such as a flash memory.

The transmission/reception unit transmits and/or receives radio signal waves via an antenna. The communication control unit modulates and demodulates a carrier signal by means of a ringing signal, a dialing signal, or the like, and generates a radio signal wave for transmission or reception.

The speech processing unit is connected to the speaker and the microphone, and is configured to convert an analog speech signal picked by the microphone into a digital signal and to convert a digital speech signal output from the control unit into an analog signal. The speaker is used to play back a speech signal output from the control signal or a speech signal picked by the microphone.

The display unit is formed of, for example, a liquid crystal display (LCD) device, and is configured to display various input information or output information to and from the control unit.

The operation unit includes, for example, a ten-key pad, an off-hook key, an on-hook key, a function key, and an up-down-right-left key. The user can use the operation unit to enter a telephone number or an email address, to invoke and perform the functions of the cellular phone, and to perform functions of the IC section 201. The functions of the IC section 201 include storing electronic money. The user can use the operation unit to store electronic money. The information regarding the electronic money is stored in the EEPROM 704.

FIG. 3 is an exploded perspective diagram showing the mounting of the magnetic sheet 204 in the cellular phone according to the preferred embodiment of the present invention.

In FIG. 3, in order to clarify the arrangement of the magnetic sheet 204, the components located in the vicinity of the magnetic sheet 204 are illustrated in a hierarchical fashion.

On the printed circuit board 206 having the IC section 201 thereon, the battery 205 and the battery cover 203 are mounted as layers.

The antenna 202 is arranged so as to surround the battery 205, and the magnetic sheet 204 is also arranged so as to surround the battery 205. The antenna 202 and the magnetic sheet 204 are arranged in the form of loops around the battery 205, thus preventing an increase in the thickness of the cellular phone. The magnetic sheet 204 arranged around the battery 205 is mounted so as to be bonded to a housing (not shown) of the cellular phone.

In the embodiment, the area of the battery cover 203 is smaller than the area of the loop of the antenna 202. However, the area of the battery cover 203 may be larger than the area of the loop of the antenna 202 so as to cover the antenna 202.

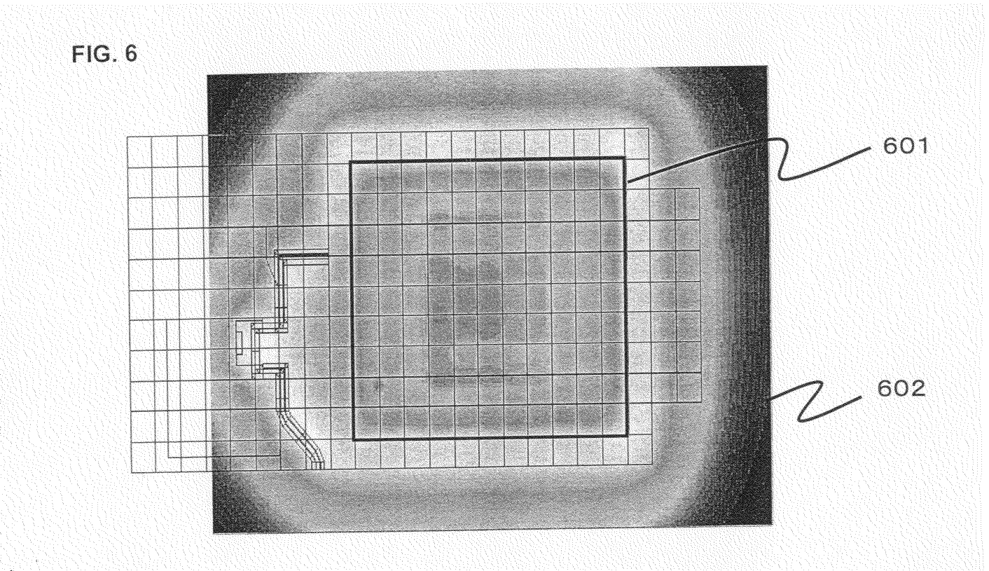

FIG. 6 is a diagram showing a magnetic field distribution when the magnetic sheet 204 is arranged around the battery 205.

The magnetic sheet 204 is arranged around the battery 205 inside the loop of the antenna 202.

In FIG. 6, the magnetic field strength is given by brightness. The brighter, the higher the magnetic field strength, whereas the darker, the lower the magnetic field strength.

The magnetic field in the vicinity of the antenna 202 is strong. A frame 601 represents a region in which the battery 205 is positioned, and the inside of the frame 601 is darker than the outside. That is, the magnetic field strength inside the frame 601 is lower than that in the vicinity of the antenna 202.

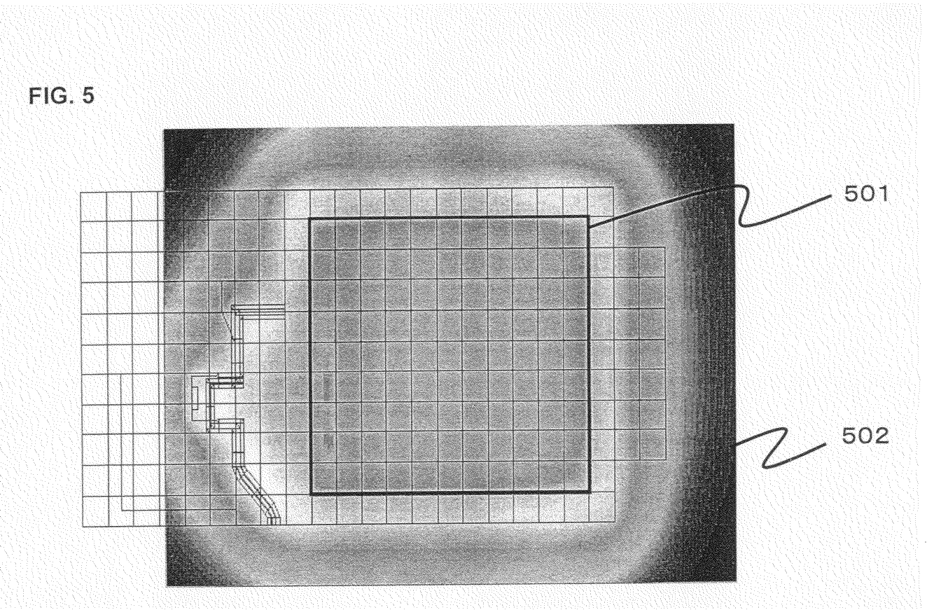

In the periphery of the frame 601 (around the battery 205), a demagnetizing field due to eddy currents is suppressed by the magnetic sheet 204. As a result, the magnetic field in the periphery of the frame 601 (around the battery 205) is strong, and the periphery of the frame 601 is brighter than that of the frame 501 shown in FIG. 5. The magnetic field strength over an entire magnetic field observation surface 602 is 33,246 μA/m, and is higher than the magnetic field strength over the entire magnetic field observation surface 502, namely, 32,819 μA/m, in the magnetic field distribution shown in FIG. 5.

Therefore, the eddy-current shielding effect is more pronounced in the case of the magnetic sheet 204 formed around the side surface of the battery 205 than that formed around the top surface, resulting in improved communication characteristics of the antenna 202.

The magnetic sheet 204 may be formed around the side surface and the top surface of the battery 205, whereby the communication characteristics of the antenna 202 can further be improved.

Technical features according to the present invention can be represented by various levels and variations ranging from a generic concept to more specific concepts.

What is claimed is:

1. A radio communication apparatus, comprising:
a housing;
a battery for driving the radio communication apparatus;
an antenna provided in the housing; and
a magnetic sheet arranged around the battery.

2. The radio communication apparatus according to claim 1, wherein the antenna is arranged around the battery.

3. The radio communication apparatus according to claim 2, wherein the antenna is in the form of a loop, and is arranged so as to surround the battery.

4. The radio communication apparatus according to claim 3, wherein the magnetic sheet is arranged inside the loop of the antenna.

5. The radio communication apparatus according to claim 4, wherein the magnetic sheet is arranged so as to be spaced from the battery.

6. The radio communication apparatus according to claim 5, wherein the magnetic sheet is further arranged to be spaced from the antenna.

7. The radio communication apparatus according to claim 6, wherein the magnetic sheet is bonded to the housing of the radio communication apparatus.

8. The radio communication apparatus according to claim 1, wherein the magnetic sheet is arranged around the side surface of the battery.

9. The radio communication apparatus according to claim 8, wherein the magnetic sheet is in the form of a loop.

10. The radio communication apparatus according to claim 9, wherein the magnetic sheet is arranged so as to surround the battery.

11. The radio communication apparatus according to claim 1, wherein the magnetic sheet is in the form of a loop.

12. The radio communication apparatus according to claim 11, wherein the magnetic sheet is arranged so as to surround the battery.

13. The radio communication apparatus according to claim 4, wherein the magnetic sheet is in the form of a loop.

14. The radio communication apparatus according to claim 13, wherein the magnetic sheet is arranged so as to surround the battery.

15. The radio communication apparatus according to claim 14, wherein the magnetic sheet is arranged so as to be spaced from the battery.

16. The radio communication apparatus according to claim 15, wherein the magnetic sheet is further arranged to be spaced from the antenna.

17. The radio communication apparatus according to claim 16, wherein the magnetic sheet is bonded to the housing of the radio communication apparatus.

18. The radio communication apparatus according to claim 1, wherein the magnetic sheet shields the antenna form a magnetic field induced by the battery.

19. A radio communication apparatus, comprising:
a housing;
a battery for driving the radio communication apparatus;
an antenna provided in the housing and arranged around the battery; and
a sheet arranged between the antenna and the battery, for shielding the antenna form a magnetic field induced by the battery.
